(19) United States
(12) Patent Application Publication
(10) Pub. No.: US 2026/0369285 A1
(43) Pub. Date: Nov. 19, 2026

(54) APPARATUS, METHODS AND COMPUTER PROGRAM FOR SELECTING A MODE FOR AN INPUT FORMAT OF AN AUDIO STREAM

(71) Applicant: Nokia Technologies Oy, Espoo (FI)

(72) Inventors: Lasse Juhani Laaksonen, Tampere (FI); Sujeet Shyamsundar Mate, Tampere (FI); Lauros Pajunen, Helsinki (FI); Tapani Pihlajakuja, Kellokoski (FI)

(21) Appl. No.: 19/487,536

(22) PCT Filed: May 6, 2024
(86) PCT No.: PCT/EP2024/062424

§ 371 Date: Nov. 25, 2025

(30) Foreign Application Priority Data
Jun. 1, 2023 (GB) 2308213.4

(51) Int. Cl. G10L 19/16

(52) U.S. Cl. CPC G10L 19/167; G10L 19/173

(57) ABSTRACT

Examples of the disclosure relate to selecting a mode for an input format of an audio stream including signals mixed from different sources. An indication of one or more modes available for a selected input format of a first audio signal is obtained. An indication of one or more modes available for a selected input format of a second audio signal is also obtained. The first audio signal and the second audio signal are to be combined to form an audio stream. In examples a mode is selected for the audio stream including both the first audio signal and the second audio signal wherein the selection is based, at least in part, on one or more common modes available for the selected input format of the first audio signal and the selected input format of the second audio signal.

### TECHNOLOGICAL FIELD

Examples of the disclosure relate to apparatus, methods and computer programs for selecting a mode for an input format of an audio stream. Some relate to apparatus, methods and computer programs for selecting a mode for an input format of an audio stream comprising signals mixed from different sources.

### BACKGROUND

Audio applications such as teleconferencing can obtain audio signals from different sources or capture setups. These different signals can be mixed together to generate an audio stream that can be sent to participants in the teleconference or other audio application. If the signals from the different sources or capture setups use different modes for the input this can adversely affect the quality of the signal components in the audio stream.

### BRIEF SUMMARY

According to various, but not necessarily all, examples of the disclosure there is provided an apparatus comprising means for:
obtaining an indication of one or more modes available for a selected input format of a first audio signal wherein the first audio signal is received from a first source;
obtaining an indication of one or more modes available for a selected input format of a second audio signal wherein the second audio signal is received from a second source and wherein the first audio signal and the second audio signal are to be combined to form an audio stream;
selecting a mode for the audio stream comprising both the first audio signal and the second audio signal wherein the selection is based, at least in part, on one or more common modes available for the selected input format of the first audio signal and the selected input format of the second audio signal;
sending an indication of the selected mode to the respective sources.

The indications of the available modes may be received for more than two audio signals from different sources and different audio signals can have different modes available for selected input formats and wherein the audio signals are to be combined to form an audio stream.

The selected mode may comprise a mode that is common to two or more audio signals where the audio signals are from two or more sources.

The mode may be selected, based at least in part on at least one of the following:
most common available mode for the selected input formats for the sources;
computational load for mixing the audio signals from the sources into a combined stream in the respective available modes for the selected input formats;
computational load for decoding the audio signals from the sources and/or encoding a mixed audio stream in the respective available modes for the selected input formats.

The means may be for mixing at least the first audio signal and at least the second audio signal using a common mode to generate a mixed audio stream in the selected mode and enabling transmission of the mixed audio stream.

The selected mode may comprise a first mode for an audio main stream and a second mode for an audio substream.

The main stream may comprise a mix of two or more audio signals with a common mode in the selected input formats.

The means may be for enabling the main stream and the sub stream to be transmitted without mixing the main stream and the substream.

The means may be for receiving an indication of a preferred mode for an end user device and using the indication of the preferred mode to assist the selecting of the mode for the audio stream.

The audio signals may comprise metadata assisted spatial audio signals.

The selected input formats may comprise a metadata assisted spatial audio format.

The one or more modes available for an input format may comprise a time-frequency resolution.

At least one of the available modes may comprise a higher frequency resolution and at least one of the available modes may comprise a higher temporal resolution.

The means may be for generating spatial metadata using the selected mode.

According to various, but not necessarily all, examples of the disclosure there is provided a method comprising:
obtaining an indication of one or more modes available for a selected input format of a first audio signal wherein the first audio signal is received from a first source;
obtaining an indication of one or more modes available for a selected input format of a second audio signal wherein the second audio signal is received from a second source and wherein the first audio signal and the second audio signal are to be combined to form an audio stream;
selecting a mode for the audio stream comprising both the first audio signal and the second audio signal wherein the selection is based, at least in part, on one or more common modes available for the selected input format of the first audio signal and the selected input format of the second audio signal;
sending an indication of the selected mode to the respective sources.

According to various, but not necessarily all, examples of the disclosure there is provided a computer program comprising program instructions which, when executed by an apparatus, cause the apparatus to perform at least:
obtaining an indication of one or more modes available for a selected input format of a first audio signal wherein the first audio signal is received from a first source;
obtaining an indication of one or more modes available for a selected input format of a second audio signal wherein the second audio signal is received from a second source and wherein the first audio signal and the second audio signal are to be combined to form an audio stream;
selecting a mode for the audio stream comprising both the first audio signal and the second audio signal wherein the selection is based, at least in part, on one or more common modes available for the selected input format of the first audio signal and the selected input format of the second audio signal;
sending an indication of the selected mode to the respective sources.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

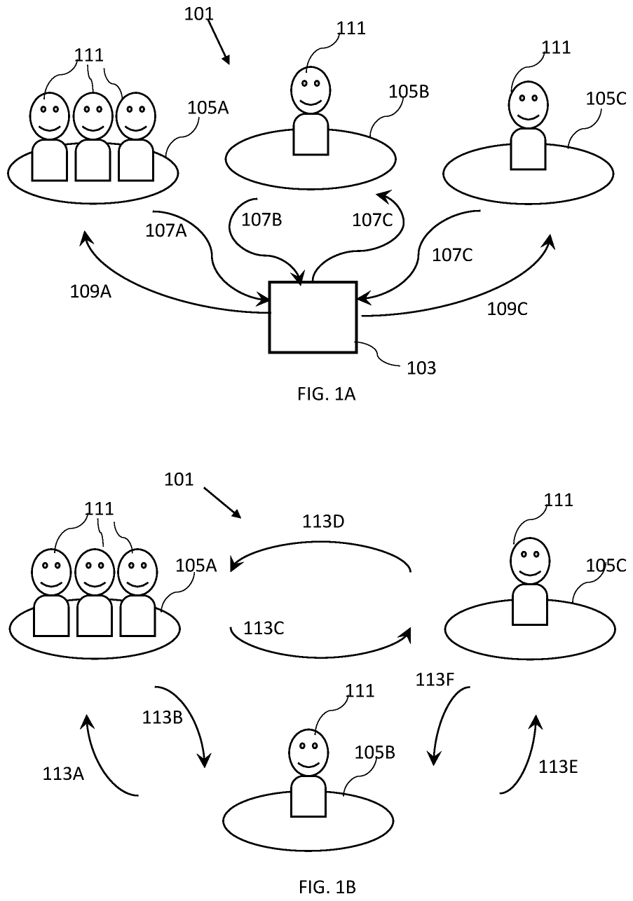

FIGS. 1A and 1B show example systems;

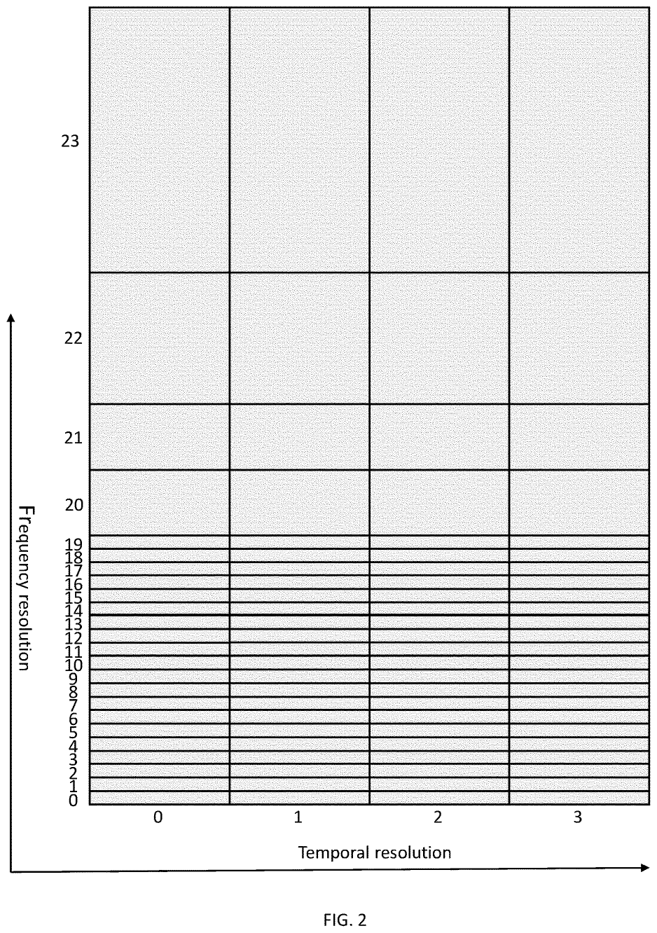

FIG. 2 shows an example metadata frame;

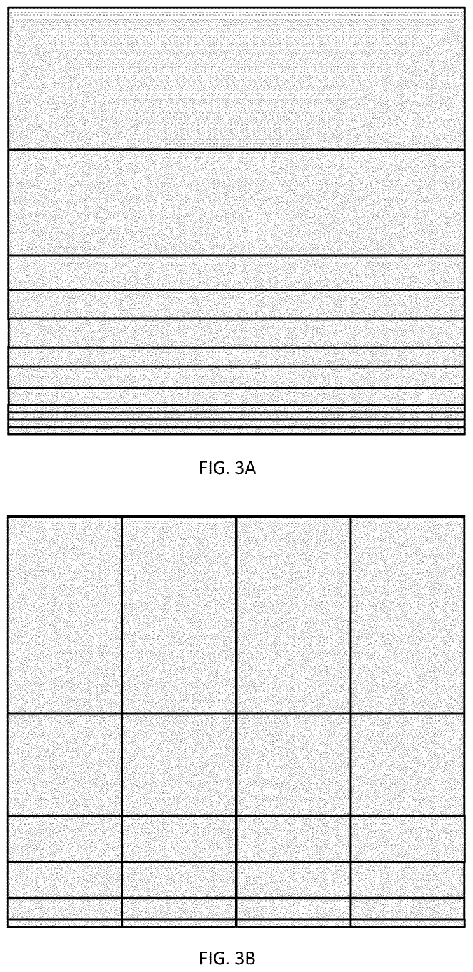

FIGS. 3A and 3B show an example metadata frames;

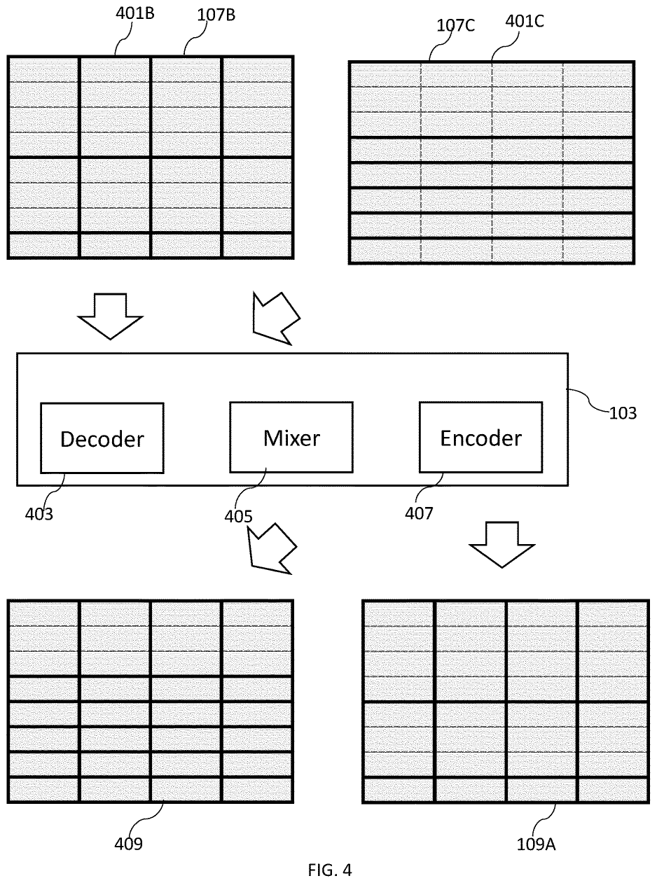

FIG. 4 shows mixing of an audio stream;

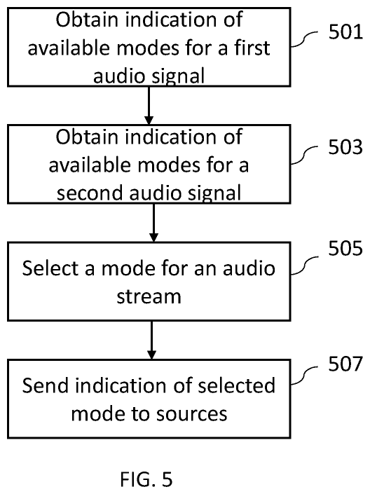

FIG. 5 shows an example method;

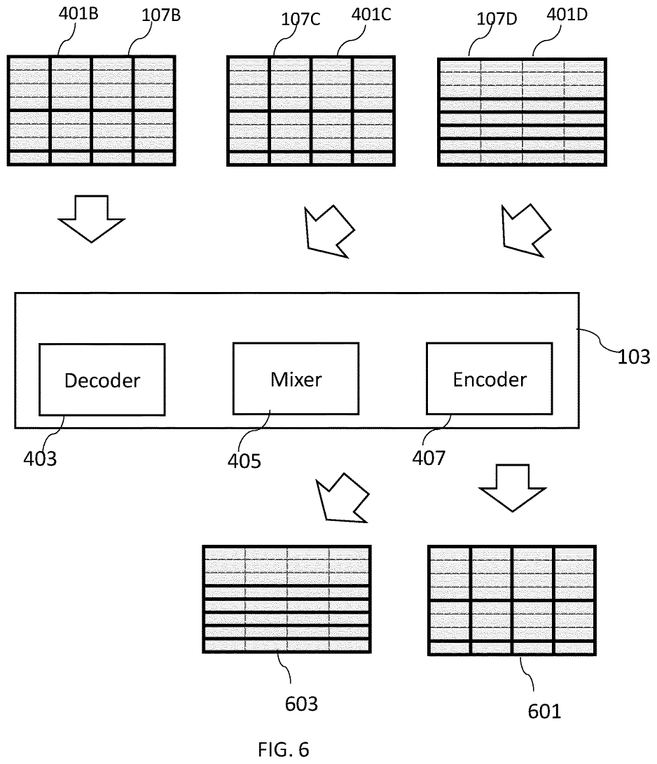

FIG. 6 shows mixing of an audio stream;

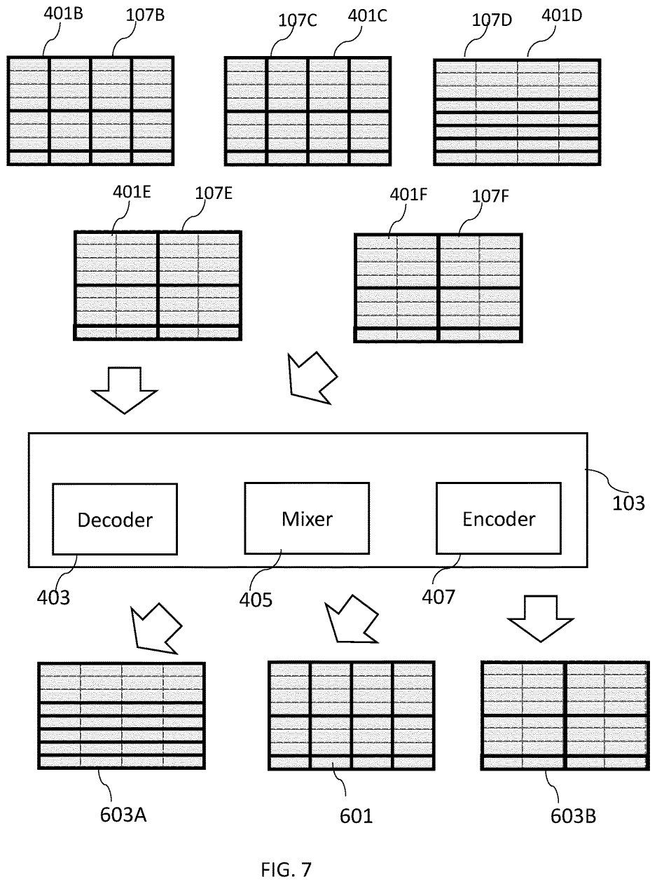

FIG. 7 shows mixing of an audio stream;

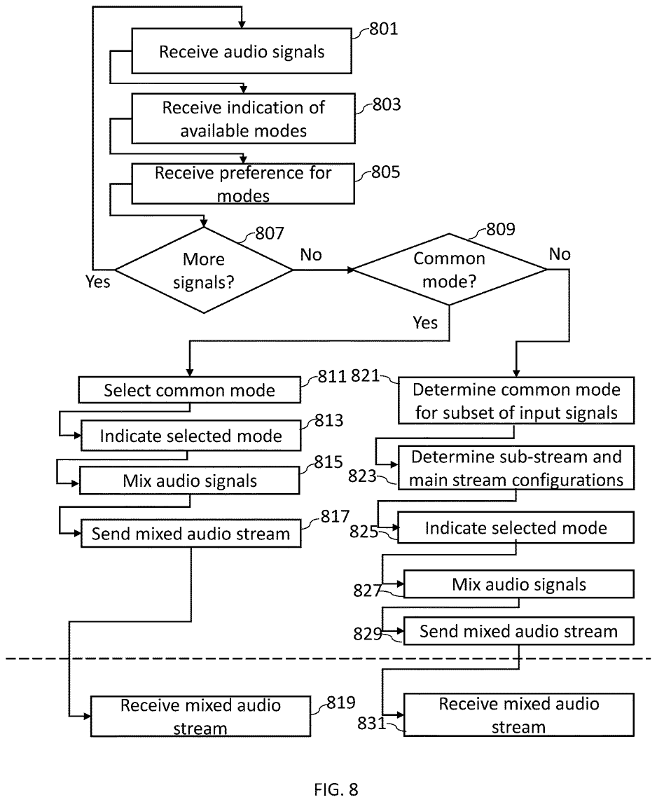

FIG. 8 shows an example method;

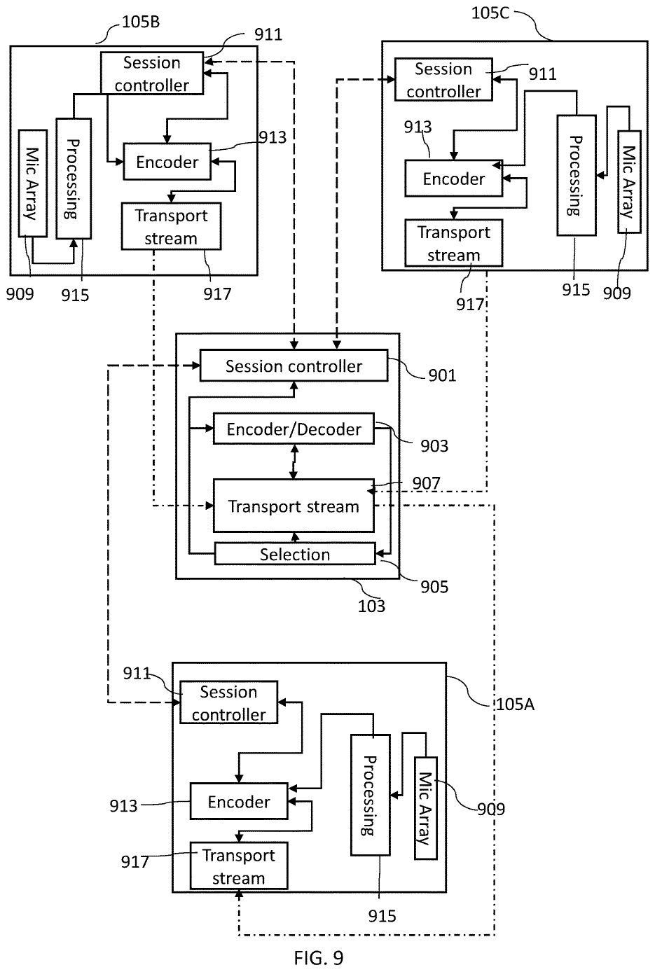

FIG. 9 shows an example system; and

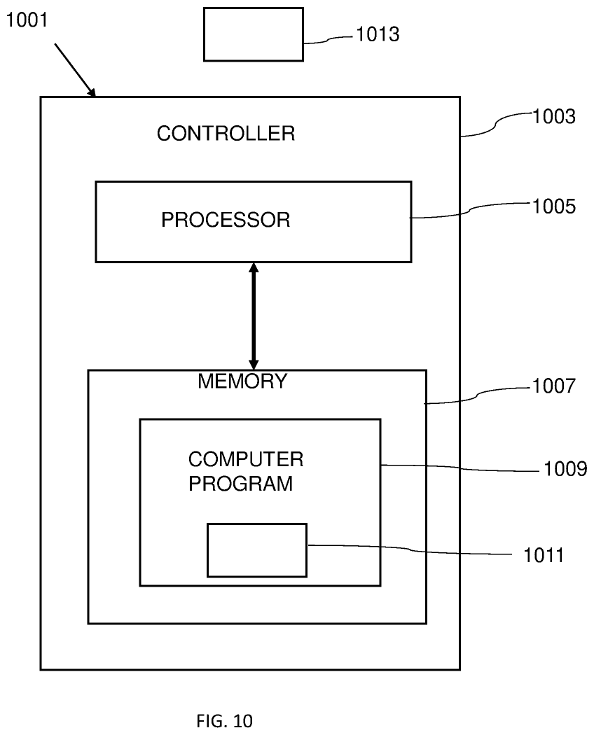

FIG. 10 shows an example apparatus.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Corresponding reference numerals are used in the figures to designate corresponding features. For clarity, all reference numerals are not necessarily displayed in all figures.

### DETAILED DESCRIPTION

Examples of the disclosure can be implemented in audio systems that make use of the immersive voice and audio services (IVAS) codec.

FIGS. 1A and 1B schematically show example systems 101 that can be used to implement examples of the disclosure. The example systems can use the IVAS codec.

The systems 101 are configured to enable audio to be captured by participant devices 105 at one or more locations and transmitted to other participant devices 105 within the system 101. This can enable audio to be shared between different participant devices 105 within the system 101. The systems 101 can be used for teleconferencing or for any other suitable audio applications.

In the example of FIG. 1A the system 101 comprises a control unit 103 and three participant devices 105A, 105B, 105C. The system 101 could comprise other types and numbers of devices in other examples.

The control unit 103 is configured to receive audio signals from sources within the system 101. In this example the sources can be the participant devices 105A, 105B, 105C. The audio signals from the participant devices 105A, 105B, 105C could comprise audio generated by the users 111 of the participant devices 105, for example it can comprise voice signals or any other suitable type of audio.

The participant devices 105A, 105B, 105C can comprise any suitable type of devices. The participant devices 105A, 105B, 105C could comprise teleconferencing devices, mobile telephones, personal computers or any other suitable type of devices that can be configured to capture audio and provide play back audio signals to a user 111.

The system 101 is configured so that the participant devices 105A, 105B, 105C transmit upstream signals 107 to the control unit 103. The upstream signals 107 can comprise audio captured by the respective participant devices 105A, 105B, 105C. the audio can come from any sound sources in the locations of the respective participant devices 105A, 105B, 105C. In the example of FIG. 1A the sound sources comprise the users 111 who are using the participant devices 105A, 105B, 105C. The users 111 could be talking or otherwise communicating in the teleconference. The different participant devices 105A, 105B, 105C therefore provide different sources for of audio signals.

The control unit 103 can be configured to receive audio signals from multiple sources. In this case the audio signals comprise the upstream signals 107A, 107B, 107C from the participant devices 105A, 105B, 105C.

The control unit is configured to mix the audio signals from the multiple sources to generate an audio stream. The control unit 103 can then provide the audio stream in downstream signals 109A, 109B, 109C to the respective participant devices 105A, 105B, 105C. This enables audio content to be shared between multiple different participant devices 105A, 105B, 105C at different locations.

The system 101 is configured so that the first participant device 105A receives a downstream signal 109A from the control unit 103. The downstream signal 109A comprises packets based on the input format. The input format could be metadata-assisted spatial audio (MASA) or any other suitable format. The downstream signal 109A that is sent from the control unit 103 to the first participant device 105A is formed based on input audio signals from the other participant devices 105B, 105C in the system 101. The control unit 103 is configured to decode the received upstream signals from the other participant devices 105B, 105C and mix the decoded signals into a combined format. The mixed signal can then be encoded for transmission to the first participant device 105A. The first participant device 105A will receive the packets in the downstream signal 109A, decode the IVAS bitstream withing the signal and render the signal using the appropriate format for playback to the users 111 of the first participant device 105A. For instance, the signal can be rendered binaurally for playback via headphones. The control unit can similarly mix and transmit signals for the other participant devices 105B, 105C.

FIG. 1B shows a different system 101 in which there is no control unit 103. In this system 101 the audio signals can be sent directly between the participant devices 105A, 105B, 105C.

In the system of FIG. 1 a first audio signal 113A is sent from the first participant device 105A to the second participant device 105B, a second audio signal 113B is sent from the second participant device 105B to the second participant device 105A, a third audio signal 113C is sent from the first participant device 105A to the third participant device 105C, a fourth audio signal 113D is sent from the third participant device 105C to the first participant device 105A, a fifth audio signal 113E is sent from the second participant device 105B to the third participant device 105C, and a sixth audio signal 113E is sent from the third participant device 105C to the second participant device 105B.

The audio signals that are sent by the participant devices 105A, 105B, 105C can comprise audio that has been captured by the respective participant devices 105A, 105B, 105C. The audio signals that are captured by a participant device can also be mixed with audio signals that have been received from another source such as another participant devices 105A, 105B, 105C.

As shown in both FIG. 1A and FIG. 1B more than one user 111 can be using a participant device 105A, 105B, 105C. For instance, in the example of FIGS. 1A and 1B three users 111 are using the first participant device 105A, only one user 111 is using the second participant device 105B, and only one user 111 is using the third participant device 105C. The system 101 could comprise different numbers of users 111 and participant devices 105 in other examples.

The IVAS codec can be used in telecommunication systems 101 such as the systems 101 of FIGS. 1A and 1B. The IVAS codec can support various input formats. The various input formats can comprise stereo, multichannel (MC), object-based audio (ISM), scene-based audio (SBA), and MASA. Some combinations can be supported by various means, e.g., Objects with MASA (OMASA) or Objects with SBA (OSBA) combined format(s) can be used. A separate input format exists for binaural audio, which can operate the same as stereo input.

The MASA input format uses one or more audio signals together with corresponding spatial metadata. The MASA spatial metadata parameters describe the spatial characteristics of the captured spatial sound scene. The spatial metadata can comprise information such as directions and direct-to-total energy ratios in frequency bands or any other relevant spatial information.

A MASA audio stream can be obtained by the participant devices 105 in systems 101 such as the systems 101 shown in FIGS. 1A and 1B. For instance, a MASA audio stream could be obtained by capturing spatial audio with microphones of a participant device 105 and the corresponding spatial metadata can be estimated based on the microphone signals.

A MASA stream can be obtained also from other sources, such as specific spatial audio microphones (such as Ambisonics), studio mixes (such as, 5.1 mix) or other content by implementing a suitable format conversion.

It is also possible to use MASA tools inside a codec for encoding multichannel channel signals by converting the multichannel signals to a MASA stream and encoding that stream.

This parametric representation of the MASA metadata is based on frequency bands. A certain spatial characteristic relates to a frequency band, and a neighbouring frequency band can exhibit a different characteristic. For MASA format, 24 frequency bands are used. The metadata frame corresponding to 20-ms frame of audio is divided into four subframes of 5 ms each. The parametric representation in each frame therefore consists of 24 frequency bands in 4 time slots giving a total of 96 time-frequency tiles.

The frame size in IVAS is 20 ms and thus the temporal sub-frame is 5 ms. In addition, MASA supports one or two directions for each time-frequency tile (that is, there are one or two 2 direction indices, direct-to-total energy ratio, and spread coherence parameters for each time-frequency tile).

FIG. 2 schematically shows the time-frequency resolution of an IVAS MASA metadata frame. A metadata frame configured to be processed by an IVAS encoder comprises 96 time-frequency (TF) tiles.

Various encoding methods, especially at lower bit rates, can reduce the effective TF resolution. This reduction could happen in terms of reducing temporal resolution only, reducing frequency resolution only, or reducing both. The effective input TF resolution can also differ from what the MASA format supports. For example, the same parameter values could be repeated for temporal subframes 0, 1, 2, 3 thus providing a reduced temporal resolution. Similarly, some of the frequency bands could have the same parameter values as some adjacent frequency bands in the same temporal subframe thus providing a reduced frequency resolution.

FIGS. 3A and 3B schematically show reductions in the TF resolution of an example IVAS MASA metadata frame. The different TF resolutions can be used in different modes used for the MASA input format.

The metadata frame in FIG. 3A shows reduced temporal and frequency resolution. The metadata frame in FIG. 3A has twelve effective frequency bands and one effective temporal subframe. This provides twelve TF tiles.

The metadata frame in FIG. 3B shows another frame with reduced temporal and frequency resolution. The metadata frame in FIG. 3B has six effective frequency bands and four effective temporal subframes. This provides twenty-four TF tiles.

The metadata frames shown in FIGS. 3A and 3B are for examples only. Other reductions in TF resolution can be used in different modes of the MASA input format. For instance, one or more input modes could use eighteen frequency bands and one temporal subframe. This would provide eighteen TF tiles. Another one or more input modes could use five frequency bands and four temporal subframes. This would provide twenty TF tiles.

The metadata frames shown in FIGS. 3A and 3B are schematic representations of the frames. An input IVAS MASA metadata frame must have ninety-six TF tiles. The (effective) TF resolution can only be reduced by repeating parameter values. However, in other contexts the effective TF resolution can correspond to an actual representation. For instance, inside a codec only the repeated values are “stored”

With reducing bit rate it may also be needed to reduce the TF resolution as part of the encoding. In scenarios where there are fewer metadata parameter values to be encoded, it is easier to encode them all with reasonable accuracy for reproduction at the decoder/renderer. This reduction can generally be done at least based on the contents (values) of the input spatial metadata, but often also by considering the transport signal characteristics such as its energy. The transport signal characteristics can also be analysed per TF tile.

Problems can arise in systems 101 where audio from different sources is to be mixed. If the audio sources use different modes of an input format they could have different TF resolutions. As an illustrative example, in the system 101 of FIG. 1A the second participant device 105B could generate a MASA input format with a full TF resolution. An IVAS encoder on the second participant device 105B encodes the input audio signal according to a negotiated bit rate and transmits the encoded signal to the control unit 103. The third participant device 105C could generate a MASA input format with a reduced TF resolution. An IVAS encoder on the third participant device 105C also encodes the input audio signal according to a negotiated bit rate and transmits the encoded signal to the control unit 103. A significant reduction in the TF resolution could be applied to both of the input streams due to the bit rates. The reductions could be different for the respective participant devices 105. For instance, the encoder on the second participant device 105B would likely be configured to maintain the temporal resolution and therefore would lose more frequency resolution while the encoder on the third participant device 105C would be configured to maintain the frequency resolution because the input signal already has a lower effective temporal resolution.

The individual input signals from the respective participant devices 105B, 105C can have good quality however the difference in TF resolution can be problematic when the different input signals are mixed by the control unit 103. If the mixing is configured to try to maintain best possible quality for both input signals then the resulting mixed signal will have high temporal resolution (from the second participant device 105B) and high frequency resolution (from the third participant device 105C). However, a new TF resolution reduction may need to be carried out to encode the mixed signal for transmission to the first participant device 105A at the available bit rate. In many cases, this can reduce the quality of at least one of the respective input signals or component input signals of the mix. In this particular example the input signal from the third participant device 105C could be significantly affected.

FIG. 4 schematically shows mixing of an audio stream and how the mixing of input signals with different TF resolution can affect the quality of the output signals.

In FIG. 4 an upstream signal 107B from the second participant device 105B and an upstream signal 107C from the third participant device 105C are received by the control unit 103. Metadata frames 401 of the respective upstream signals 107B, 107C are shown in FIG. 4.

The metadata frame 401B for the upstream signal 107B from the second participant device 105B shows reduced frequency resolution. The metadata frame 401B has three effective frequency bands and four effective temporal subframes. This provides twelve TF tiles.

The metadata frame 401C for the upstream signal 107C from the third participant device 105C shows reduced frequency resolution and reduced temporal resolution. The metadata frame 401C has six effective frequency bands and one effective temporal subframes. This provides six TF tiles.

The control unit 103 comprises a decoder 403, a mixer 405 and an encoder 407.

The input signals 107B, 107C from the respective participant devices 105B, 105D are provided as an input to the decoder 403. The decoder 403 decodes the input signals 107B, 107C and provides the decoded input signals to the mixer 405.

The mixer 405 mixes the decoded input signals. The mixer 405 generates an intermediate mix 409 that is provided as an input to the encoder 407. The mixer 405 can be configured to retain as much information as possible in the intermediate mix 409. In the example of FIG. 4 the intermediate mix has six effective frequency bands and four effective temporal subframes. This provides twenty-four TF tiles.

The encoder 407 is configured to mix the intermediate mix to provide a downstream signal 109A that can be transmitted to the first participant device 105A. The encoder 407 might need to reduce the TF resolution due to the bit rate or for any other reason.

In this case the output of the encoder 409 has three effective frequency bands and four effective temporal subframes. This provides twelve TF tiles. The TF resolution for the signal 107B from the second participant device 105B is maintained but the TF resolution for the signal 107C from the third participant device 105C. The signal 107C from the third participant device 105C does not gain any temporal resolution in the operations performed by the control unit 103 because this information cannot be added.

This reduction in TF resolution for, at least some of the components, of the output signal can reduce the quality of the audio for the users 111 of the participant devices 105. Examples of the disclosure are configured to avoid this reduction in audio quality.

FIG. 5 shows an example method. The method could be implemented by a control unit and/or a participant device 105 and/or any other suitable device within an example system 101. The method could be performed during session negotiation or at any other suitable time.

The method comprises; at block 501, obtaining an indication of one or more modes available for a selected input format of a first audio signal wherein the first audio signal is received from a first source.

At block 503 the method comprises obtaining an indication of one or more modes available for a selected input format of a second audio signal wherein the second audio signal is received from a second source. The first audio signal and the second audio signal are to be combined to form an audio stream.

In the example of FIG. 5 the indications of the available modes are received for two different audio signals from two different sources. Indications of the available modes could be received for more than two audio signals from different sources and different audio signals can have different modes available for selected input formats. The multiple different audio signals from the multiple different sources can be combined to form an audio stream.

The input signals can be upstream audio signals as shown in FIG. 1A or could be any other suitable type of signals. The sources from which the audio signals are received could be participant devices 105 within a system 101 or could be any other suitable type of source of audio signal.

The input format specifies the format that is used for signals that are provided to an encoder. The various input formats can comprise stereo, MC, ISM, SBA, and MASA and/or any other type of format.

The input formats can have different modes available. The different modes can comprise different operating modes of the input format. As an example, the available input modes for the MASA input format could comprise a high-frequency resolution (HFR, 1-subframe, 1sf mode) and a high-time resolution mode (HTR, 4-subframe, 4sf mode).

The modes available for an input format comprise a TF resolution. Different modes can have different TF resolutions. In some examples at least one of the available modes comprises a higher frequency resolution and at least one of the available modes comprises a higher temporal resolution.

At block 505 the method comprises selecting a mode for the audio stream comprising both the first audio signal and the second audio signal. The selection of the mode is based, at least in part, on one or more common modes available for the selected input format of the first audio signal and the selected input format of the second audio signal.

In some examples the selected mode can comprise a mode that is common to two or more audio signals where the audio signals are from two or more sources. For instance, if there is a mode that is available for both the input format of the first audio signal and the input format of the second audio signal then this could be the selected mode.

In some examples the selected mode can be selected, based at least in part on, the most common available mode for the selected input formats for the respective sources. The most common available mode can be the mode that is indicated as being available for the selected input format for the most audio signals. The most common mode can be the mode that is available for the largest number of participant devices 105.

In some examples the mode can be selected based on the audio quality that the mode provides. If a particular mode provides better audio quality than other available modes then the mode with the better audio quality can be selected.

In some examples the mode can be selected based on capabilities of the control unit 103 or any other suitable device. For instance, the mode can be selected based on the computational load it takes to mix the input audio signals into the audio stream.

In some examples the selected mode can be selected, based at least in part on a computational load for mixing the audio signals from the sources into a combined stream in the respective available modes for the selected input formats. In such examples a mode that would result in a lower computational load for mixing could be prioritized over a mode that would result in a higher computational load.

In some examples the selected mode can be selected, based at least in part on a computational load for decoding the audio signals from the sources and/or encoding a mixed audio stream in the respective available modes for the selected input formats.

In such examples a mode that would result in a lower computational load for decoding and/or encoding could be prioritized over a mode that would result in a higher computational load.

In some examples selecting a mode for the audio stream can comprise selecting more than one mode. In such cases the mixed audio stream can comprise different components. For instance, the audio stream can comprise an audio main stream and one or more audio substreams. The main stream can differ from the substream in that the main stream can be prioritized over any substreams and/or that the main stream can comprise more data than the one or more substreams. In such cases the selected mode can comprise a first mode for an audio main stream and a second mode for an audio substream.

In some examples the respective components of the mixed audio stream can comprise a mix of two or more audio signals. For instance, the main stream, and or one or more of the substreams, can comprise a mix of two or more audio signals with a common mode in the selected input formats.

In examples where the audio stream comprises different components the mixed audio stream can be transmitted without mixing the respective components. For instance, the mixed audio stream can be transmitted without mixing the main stream and the one or more substreams.

At block 507 the method comprises sending an indication of the selected mode to the respective sources.

In some examples the method can also comprise additional blocks that are not shown in FIG. 5. For instance, in some examples the method can comprise mixing at least the first audio signal and at least the second audio signal using a common mode to generate a mixed audio stream in the selected mode and enabling transmission of the mixed audio stream. The mixed audio stream can be transmitted to a participant device 105, or to any other suitable device or devices, so as to enable the audio to played back to a user.

In some examples the method can comprise receiving an indication of a preferred mode for a participant device 105 and using the indication of the preferred mode to assist the selecting of the mode for the audio stream. The participant device 105 could be associated with an end user. That is the participant device could be the device to which the mixed audio stream is to be transmitted.

The audio signals that are used could be metadata assisted spatial audio signals or any other suitable type of signals. The selected input format that is used for the audio signals could comprise a MASA format or any other suitable type of format. The method may also comprise generating spatial metadata using the selected mode.

Examples of the disclosure can be used to address the problems with TF resolutions that arise when mixing audio signals of different modes as shown in FIG. 4. In this example each of the participant devices 105B, 105C would indicate which modes they have available for the selected input format. The different modes can have different TF resolutions.

If one or more of the participant devices 105B, 105C only has a single mode available to it then the control unit 103 could request that all participant device 105B, 105C used the same mode to produce the audio signals for input to the decoder 403. If the participant devices 105B, 105C have multiple modes available for the selected input format then the control unit 103 can select a mode that is to be used for the mixed audio stream. The mode can be selected so that it retains quality for most senders at a given bit rate.

As an example, if one or more transmitting device cannot use a mode with a high temporal resolution (such as a 4sf mode) then the control unit 103 can select a mode with a lower temporal resolution (such as 1sf mode). The control unit 103 can then send an indication of this selected mode with a low temporal resolution to all of the relevant participant devices 105. The respective participant devices can then use this mode to generate the audio signals for transmission.

In some cases the participant devices 105 might need to modify the audio signals to adjust them to the selected mode. In this case the participant devices 105 would need to reduce the temporal resolution of the audio signals. The temporal resolution of the audio signals could be reduced by selecting one of the subframe values (for each parameter for each frequency) and overwriting the other subframes by this value. Other modifications for reducing the temporal resolution could be used in other examples. In some examples a spatial analysis with lower temporal (and potentially higher frequency) resolution can be used.

FIG. 6 schematically shows mixing of an audio stream. In this example a control unit 103 receives input signals 107 from three sending participant devices 105. The control unit 103 can be configured to select an appropriate mode for the mixed audio stream and generate the mixed audio stream so that it can be transmitted to a receiving participant device 105A.

In FIG. 6 an upstream signal 107B from a second participant device 105B and an upstream signal 107C from a third participant device 105C and an upstream signal 107D from a fourth participant device 105D are received by the control unit 103. Metadata frames 401 of the respective upstream signals 107B, 107C, 107D are shown in FIG. 6. The upstream signals 107 can be in MASA format or any other suitable format.

The upstream signal 107B from the second participant device 105B has a first mode. FIG. 6 shows an example metadata frame 401B for the upstream signal 107B from the second participant device 105B using this first mode. This mode has reduced frequency resolution. The metadata frame 401B has three effective frequency bands and four effective temporal subframes. This provides twelve TF tiles.

The upstream signal 107C from the third participant device 105C has the same mode as the upstream signal 107B from the second participant device 105B. The signals 107C from the third participant device 107C and the signals 107B from the second participant device 105B have the same TF resolution. The metadata frame 401C for the upstream signal 107C from the third participant device 105C has three effective frequency bands and four effective temporal subframes which provides twelve TF tiles.

The upstream signal 107D from the fourth participant device 105D has a different mode to the upstream signal 107B from the second participant device 105B. The metadata frame 401D for the upstream signal 107D from the fourth participant device 105D shows reduced frequency resolution and reduced temporal resolution. The metadata frame 401D has six effective frequency bands and one effective temporal subframes. This provides six TF tiles.

The input signals 107 from the respective participant devices 105 are received by the control unit 103. The input signals 107 are provided as an input to the decoder 403 of the control unit 103. The decoder 403 decodes the input signals 107 and provides the decoded input signals to the mixer 405. The mixer 405 mixes the decoded input signals to generate an audio stream that is provided as an input to the encoder 407. The encoder 407 is configured to mix the audio stream to provide a downstream signal 109A that can be transmitted to the first participant device 105A.

The control unit 103 can be configured to select a mode for the audio stream 109. The selection can be based on the any common modes available for the respective input signals 107 and/or any other suitable factors.

In the example of FIG. 6 the control unit 103 has selected to provide the different components for the audio stream. In this case the audio stream comprises a main stream 601 and one substream 603.

In this case the main stream 601 comprises a mix of two different audio signals. In this case the main stream 601 comprises a mix of the upstream signal 107B from the second participant device 105B and the upstream signal 107C from the third participant device 105C. These signals had a common mode and so had the same TF resolution. The main stream 601 uses the common mode. This results in a main stream 601 with three effective frequency bands and four effective temporal subframes which provides twelve TF tiles.

In the example of FIG. 6 the substream 603 comprises the audio signals that do not share a common mode with the audio signals used for the main stream 601. In this case the substream 603 comprises the upstream signal 107D from the fourth participant device 105D. The substream 603 uses the mode of the upstream signal 107D from the fourth participant device 105D. This results in a sub stream 603 with six effective frequency bands and one effective temporal subframe which provides six TF tiles.

In this example the main stream 601 is generated from multiple input signals 107 but the sub stream 603 is only generated from a single input signal. The main stream 601 can be prioritized over the substream 603. The main stream 601 can comprise more data than the substream 603.

The audio stream comprising the main stream 601 and the sub stream 603 is sent from the control unit 103 to the first participant device 105A. The first participant device 105A can be configured to decode the main stream 601 and the sub stream 603 separately from each other. In some examples the first participant device 105A can render the decoded main stream 601 and the decoded sub stream 603 separately. In some examples the first participant device 105A can combine the decoded main stream 601 and the decoded sub stream 603 into a combined stream and then render the combined stream.

Rendering multiple components of the audio stream might be computationally more complex than rendering an audio stream comprising a single component. If the participant device 105A prefers to operate in a mode with lower complexity then the receiver can indicate this preference to the control unit 103 or to any other suitable part of the system 101. If the participant device 105A has indicated a preference for reducing computational complexity and the participant device 105A the control unit 103 could select modes that reduce this computational complexity. For instance, the control unit 103 could negotiate with the other participant devices 105 to use a common mode so that the audio stream for the participant device 105A can comprise just one component. For instance, in the example of FIG. 6, if all of the sending participant devices 105B, 105C, 105D are capable of using the modes with the 6×1 TF resolution then the control unit 103 will request that this is used.

In some examples a preferred mixing approach, determining whether the audio stream comprises a single component or a main stream and one or more sub streams can be negotiated between the control unit 103 and the participant devices 105. The negotiations can be based on the computational capabilities and preferences of the participant devices 105 and the control unit 103.

FIG. 7 schematically shows mixing of another audio stream. In this example a control unit 103 receives input signals 107 from five sending participant devices 105. The control unit 103 can be configured to select an appropriate mode for the mixed audio stream and generate the mixed audio stream so that it can be transmitted to a receiving participant device 105A.

In FIG. 7 an upstream signal 107B from a second participant device 105B, an upstream signal 107C from a third participant device 105C, an upstream signal 107D from a fourth participant device 105D, an upstream signal 107E from a fifth participant device 105E and an upstream signal 107F from a sixth participant device 107F are received by the control unit 103. Metadata frames 401 of the respective upstream signals 107B, 107C, 107D, 107E, 107F are shown in FIG. 7. The upstream signals 107 can be in MASA format or any other suitable format.

In the example of FIG. 7 the upstream signals 107B from the second participant device 105B and the upstream signals 107C from the third participant device 105C share a common mode. FIG. 7 shows example metadata frames 401B, 401C for the upstream signals 107B, 107C from the second participant device 105B and the third participant device 105C using this common mode. This mode has reduced frequency resolution. The metadata frames 401B, 401C have three effective frequency bands and four effective temporal subframes. This provides twelve TF tiles.

The upstream signal 107D from the fourth participant device 105D has a different mode to the upstream signal 107B from the second participant device 105B. The metadata frame 401D for the upstream signal 107D from the fourth participant device 105D shows reduced frequency resolution and reduced temporal resolution. The metadata frame 401D has six effective frequency bands and one effective temporal subframes. This provides six TF tiles.

The upstream signals 107E from the fifth participant device 105E and the upstream signals 107F from the sixth participant device 105F share a common mode with each other. However, this mode is different to the modes used by the other participant devices 105B, 105C, 105D. FIG. 7 shows example metadata frames 401E, 401F for the upstream signals 107E, 107F from the fifth participant device 105E and the sixth participant device 105F using this common mode. This mode has reduced frequency resolution and reduced temporal resolution. The metadata frames 401E, 401F have three effective frequency bands and two effective temporal subframes. This provides six TF tiles.

The input signals 107 from the respective participant devices 105 are received by the control unit 103. The input signals 107 are provided as an input to the decoder 403 of the control unit 103. The decoder 403 decodes the input signals 107 and provides the decoded input signals to the mixer 405. The mixer 405 mixes the decoded input signals to generate an audio stream that is provided as an input to the encoder 407. The encoder 407 is configured to mix the audio stream to provide a downstream signal 109A that can be transmitted to the first participant device 105A.

The control unit 103 can be configured to select a mode for the audio stream 109. The selection can be based on the any common modes available for the respective input signals 107 and/or any other suitable factors.

In the example of FIG. 7 the control unit has selected to provide the different components for the audio stream. In this case the audio stream comprises a main stream 601 and multiple substreams 603A, 603B. In this case two sub streams 603A, 603B are provided. Other numbers of sub streams 603 could be used in other examples.

In this case the main stream 601 comprises a mix of two different audio signals. In this case the main stream 601 comprises a mix of the upstream signal 107B from the second participant device 105B and the upstream signal 107C from the third participant device 105C. These signals had a common mode and so had the same TF resolution. The main stream 601 uses the common mode. This results in a main stream 601 with three effective frequency bands and four effective temporal subframes which provides twelve TF tiles.

In the example of FIG. 7 the first substream 603A comprises the upstream signal 107D from the fourth participant device 105D. The first substream 603A uses the mode of the upstream signal 107D from the fourth participant device 105D. This results in a sub stream 603 with six effective frequency bands and one effective temporal subframe which provides six TF tiles.

The second substream 603B comprises a mix of the upstream signal 107E from the fifth participant device 105E and the upstream signal 107F from the sixth participant device 105F. These signals had a common mode and so had the same TF resolution. The second substream 603B uses the common mode. This results in a second substream 603B with three effective frequency bands and two effective temporal subframes which provides six TF tiles.

The audio stream comprising the main stream 601 and the multiple sub streams 603A, 603B is sent from the control unit 103 to the first participant device 105A. The first participant device 105A can be configured to decode the main stream 601 and the sub streams 603A, 603B separately from each other. In some examples the first participant device 105A can render the decoded main stream 601 and the decoded sub streams 603A, 603B separately. In some examples the first participant device 105A can combine the decoded main stream 601 and one or more of the decoded sub streams 603A, 603B into a combined stream and then render the combined stream independently of any other sub streams 603.

In examples of the disclosure the main stream 601 can have a higher preference to the substreams 603 in a processing order. Therefore if the receiving participant device 105A does not have capacity to process all of the streams the participant device 105A would process the main stream 601 in preference to the sub streams 603. In other cases the main stream 601 and the one or more sub streams 603 could be treated equally by the receiving participant device 105A. in such cases the main stream 601 would not have any preference in the processing order.

In some examples the control unit 103 or the receiving participant device 105A, or any other suitable part of a system 101 can decide which component is to be a main stream 601 and which component is to be a sub stream 603. In some cases the main stream 601 can be the component with the most input signals mixed into it. In some examples the main stream 601 can be the component with the most active input signals. In some examples the main stream 601 can be the component with the most reliable input signal connection.

The control unit 103 could use other factors to select the modes for the audio stream in some examples. For instance, the control unit 103 could select one or more modes based on keeping computational complexity low. In such cases the control unit 103 can mix the input audio signals based on the TF formats of the respective input signals.

In some examples the control unit 103 could select one or more modes based on optimizing output bitrate. In such cases the control unit 103 would avoid or minimise the use of sub streams 603 as this would increase the bit rate.

In some examples the control unit 103 could select one or more modes based on negotiations with the receiving participant device 105A. The negotiations could take into account the receiving participant device's 105A preference between bitrate, quality and number of decoding instances. A receiving participant device 105A that indicates a preference for a single decoder instance would prefer an audio stream comprising a single component from the control unit 103, or if the audio stream comprises multiple components the receiving participant device 105A might only decode one of the components. For instance, the receiving participant device 105A might only decode the main stream 601.

The mode that is selected for the input formats can be negotiated during the establishment of the session. For an IVAS session the mode can be negotiated at a Session Description Protocol (SDP) level.

As an example a specific operating mode parameter (inf-specific-mode) can be used by the respective participant devices 105 to indicate the modes available to the participant device 105 for a selected input format.

Table 1 is an example list of IVAS input formats and their corresponding modes.

TABLE 1

| IVAS input format | Modes |
|---|---|
| Stereo | XX |
| Binaural | XX |
| Multichannel (5.1, 7.1, | XX |
| 5.1.2, 5.1.4, 7.1.4) | |
| MASA | High Temporal Resolution (HTR, |
| | default), High Frequency Resolution |
| | (HFR) |
| ISM (1, 2, 3, 4 objects) | XX |
| SBA (FOA, HOA2, HOA3) | XX |
| OMASA (1, 2, 3, 4 objects) | (HTR, HFR) |

In this table only the operating modes for the MASA and OMASA input formats are shown. The operating modes for the other input formats are not listed.

In the example of table 1 the MASA and OMASA input formats have two modes. The two modes comprises a high temporal resolution (HTR) mode and a high frequency resolution (HFR) mode. The HTR mode uses four temporal subframes. The HFR mode does not use sub-framing but can have a higher number of frequency bands than the HTR mode. These modes are examples and different modes could be used instead of, or in addition to, these examples.

If a specific operating mode parameter (inf-specific-mode) is being used to indicate the available modes then a value can be assigned to the specific operating mode parameter to indicate the available modes.

The specific operating mode parameter, inf-specific-mode, can be used to indicate the available operating mode(s) for the selected input format(s). In case multiple operating modes in a range are supported, it is indicated by the first mode in the range and the last in the range separated by a hyphen (inf-specific-mode1
inf-specific-mode2). In case of multiple operating modes that are not a contiguous range but individual modes, those can be listed as comma separated values (inf-specific-mode1, inf-specific-mode2). Comma separated values can also used, when the specific operating modes are within a range, but the preferred order of the modes is not the default contiguous range. In both cases, hyphen or comma separated list, the available operating modes can be listed in a preferred order from the most preferred to the least preferred mode. An inf-specific-mode-send parameter and an inf-specific-mode-recv parameter can used in cases where different operating modes are used in the send and receive directions respectively. If inf-specific-mode is not present, this can indicate that all possible input modes are available. If a selected input formats can have only a single operating mode then the inf-specific-mode parameter is not needed.

Another parameter (disable-inf-specific-mode-switch parameter) can be used to restrict a sending participant device 105 from switching the operating mode during the communication session. For this parameter a flag can be defined to restrict the mode from switching. Permissible values for this parameter can be 0 and 1. If disable-inf-specific-mode-switch is 0 or not present, the sending participant device 105 is allowed to switch between the negotiated modes for the selected input formats during the session. If disable-inf-specific-mode-switch is 1, the sending participant device 105 is not allowed to switch the negotiated modes for the selected input formats during the session.

In some examples the available modes could be indicated by using particular values for an input format parameter (inf). Examples of the different values that could be used for the input format parameter is shown in table 2. In this case each input format and specific operating mode is given a unique inf parameter value. In this implementation, the inf-specific-mode parameter does not need to be used because the information is conveyed in the inf parameter.

TABLE 2

| | Attribute |
|---|---|
| IVAS input format | inf value |
| Stereo | 1 |
| Binaural | 2 |
| Multichannel (5.1, 7.1, 5.1.2, | 3-7 |
| 5.1.4, 7.1.4) | |
| MASA (HTR, HFR) | 8-9 |
| ISM (1, 2, 3, 4 objects) | 10-13 |
| SBA (FOA, HOA2, HOA3) | 14-16 |
| OMASA (HTR, HFR), | 17-24 |
| (1, 2, 3, 4 objects) | |

Example 1 below describes an example SDP offer-answer negotiation for initiating a session. In this case the sender offers MASA input format with HTR and HFR modes. The receiver prefers HTR MASA mode and includes only HTR in the SDP answer for the inf-specific-mode parameter.

Example 1 - An example SDP offer-answer scenario

Example SDP Offer
m = audio 49152 RTP/AVP 96
a = rtpmap: 96 IVAS/16000
a = fmtp: 96 inf = 8; inf-specific-mode = HTR, HFR; br = 512
a = ptime: 20
a = maxptime: 240
Example SDP Answer
m = audio 49152 RTP/AVP 96
a = rtpmap: 96 IVAS/16000
a = fmtp: 96 inf = 8; inf-specific-mode = HTR; br = 512
a = ptime: 20
a = maxptime: 240

The media line (m-line) describes the port used for the session (49152). RTP/AVP stands for RTP profile for audio and video and 96 is an indicator for a dynamic payload type. The type for payload number 96 is further described on the rtpmap- and fmtp-lines.

The rtpmap-line indicates the use of IVAS codec with 16 KHz timestamp clock frequency. The used clock frequency for IVAS has not been decided yet, and is subject to change before the standard is complete. Enhanced Voice Services (EVS) codec can use 16 kHz clock frequency. Timestamp is one of the fields in the fixed RTP header. It is incremented throughout the session and reflects the packet flow from a sender to a receiver. With 20 ms speech frame-blocks and 16 kHz timestamp clock frequency, the timestamp value is increased by 320 for each consecutive frame-block.

In the SDP offer, the fmtp-line indicates the selected input formats of the sending participant device 105 in the inf parameter. The numeric value refers to the inf values in Table 3 below (8=MASA). The inf-specific-mode parameter indicates the available operating modes for the offered IVAS input format. The sending device 105 offers two different operating modes for MASA: HTR (high time resolution) and HFR (high frequency resolution). A bitrate of 512 kbps is offered for the session.

The receiver sends an SDP answer to the sender with a modified fmtp-line. The receiver has chosen a preferred input format for the sender to use (8=MASA). The receiver prefers HTR mode and includes only that in the SDP answer. The sender should then only use HTR MASA input mode during the session.

The parameters br, ptime and maxptime in this example use the definitions presented in Enhanced Voice Services (EVS) specification (3GPP TS 26.445). In summary, the parameters represent:
br: Indicates the bitrate for the session in kilobits per second. The parameter can either have a single value (br0), or a hyphen-separated pair of two bitrates (br1-br2), where br1 and br2 are used as the minimum and maximum bitrates respectively.
ptime: Packet time, the length of time in milliseconds represented by the media in a packet. In IVAS, ptime is set to 20 ms.
maxptime: Indicates the maximum amount of media that can be encapsulated in each packet in milliseconds. For frame-based codecs like IVAS, the time should be an integer multiple of the frame size (20 ms for IVAS).

Table 3 shows IVAS input formats and their assigned attribute values. These values are used in example 1 above and example 2 below.

TABLE 3

| IVAS input format | Attribute inf value |
|---|---|
| Stereo | 1 |
| Binaural | 2 |
| Multichannel (5.1, 7.1, | 3-7 |
| 5.1.2, 5.1.4, 7.1.4) | |
| MASA | 8 |
| ISM (1, 2, 3, 4 objects) | 9-12 |
| SBA (FOA, HOA2, HOA3) | 13-15 |
| OMASA (1, 2, 3, 4 objects) | 16-19 |

Example 1 describes another example SDP offer-answer scenario. In this case the sender offers IVAS input format 8 (MASA) in two different operating modes: HTR and HFR and a bitrate range of 13.2-160 kbps. The receiver prefers HTR mode and indicates that by listing it as the first option in the SDP answer inf-specific-mode parameter value. Additionally, the receiver would like to avoid switching between the specific operating modes during the session and indicates this with the parameter disable-inf-specific-mode-switch=1. The sender should use MASA HTR input format during the session.

Example 2 - An example SDP offer-answer scenario

Example SDP Offer
m = audio 49152 RTP/AVP 96
a = rtpmap: 96 IVAS/16000
a = fmtp: 96 inf = 8; inf-specific-mode = HTR, HFR; br = 13.2-160
a = ptime: 20
a = maxptime: 240
Example SDP Answer
m = audio 49152 RTP/AVP 96
a = rtpmap: 96 IVAS/16000
a = fmtp: 96 inf = 8; inf-specific-mode = HTR, HFR; disable-inf-
specific-mode-switch = 1; br = 13.2-160
a = ptime: 20
a = maxptime: 240

FIG. 8 shows another example method that can be used to implement examples of the disclosure.

The method could be implemented using a system 101 as shown in FIG. 1A or using any other suitable system 101. In the example method of FIG. 8 some of the blocks are implemented by a control unit 103 or other similar means and some of the blocks are implemented by a participant device 105.

At block 801 the control unit 103 receives audio signals from two or more sending participant devices 105. The audio signals that are received can comprise information that is to be mixed into an audio stream.

At block 803 the control unit 103 receives an indication of one or more modes available for a selected input format for the sending participant devices 105. For instance, in the selected input format is MASA then the available modes could be a high frequency resolution (HFR) mode and a high temporal resolution (HTR) mode. Other modes could be available instead of, or in addition to, these modes.

At block 805 the control unit 103 receives an indication of preferences for the modes from a receiving participant device 105. For instance, the receiving participant device 105 could indicate if it prefers HFR or HTR. In other examples the receiving participant device 105 could indicate information that the control unit 103 could use to select a mode to use. For instance, the receiving participant device 105 could indicate if it prefers low computational complexity or has any other criteria that should be taken into account.

At block 807 it is determined if there are any more input signals to be mixed. The more input signals can be received from other sending participant devices 105. If there are more signals to be mixed the method returns to block 801 and blocks 801 to 805 re repeated for the next input signal. If there are no more input signals then the method proceeds to block 809.

At block 809 the control unit determines if there is a common mode available for all of the input signals. If there is a common mode available then the method proceeds to block 811. If there is not a common mode available to all of the input signals then the method proceeds to block 821.

At block 811 the method comprises selecting the common mode for use by all of the sending participant devices 105. At block 813 the control unit 103 indicates the selected mode to the participant devices 105. The control unit 103 can indicate the mode that is to be used to the sending participant devices 105. Once a sending participant device 105 has received an indication of the selected mode the sending participant device 105 will use that mode to generate the audio signals.

At block 815 the control unit 103 mixes the received input audio signals to an audio stream. The use of the common mode for all of the input signals enables the mixed audio stream to be generated without any quality degradation.

At block 817 the control unit 103 sends the mixed audio stream to the receiving participant device 105. At block 819 the receiving participant device 105 receives the mixed audio stream and performs decoding and rendering of the mixed audio stream. This can enable audio content to be played back to the user of the receiving participant device 105.

If there is not a common mode available to all of the input signals then the method proceeds to block 821. In this case the audio stream is to be mixed into a main stream 601 and one or more sub streams 603. At block 821 the control unit 103 determines if there are any common modes for a subset of the input signals. This could be a mode that is common to some, but not all of, the sending participant devices 105.

At block 823 the control unit 103 determines the configuration for the main stream 601 and the configuration for the one or more sub streams 603. The configuration for the respective streams can comprise the input signals that are to mixed to the stream and the mode that is to be used. For instance, the control unit 103 can determine that the signals with a common mode can be mixed to a main stream 601 while signals that do not have a common mode can be mixed in a sub stream 603. The main stream 601 and the sub streams 603 can be configured so that signals that use different modes are not mixed together.

At block 825 the control unit 103 indicates the selected mode to the participant devices 105. The control unit 103 can indicate the mode that is to be used to the sending participant devices 105. The selected mode can be the modes that are to be used for the main stream 601 and the one or more sub streams 603. Once a sending participant device 105 has received an indication of the selected mode the sending participant device 105 will use that mode to generate the audio signals.

At block 827 the control unit 103 mixes the received input audio signals to main stream 601 and one or more sub streams 603. A sub set of input signals that share a common mode can be mixed to the main stream 601 and the remaining input signals can be mixed to one or more sub streams.

At block 829 the control unit 103 sends the mixed audio stream comprising the main stream 601 and the one or more sub streams 603 to the receiving participant device 105. At block 831 the receiving participant device 105 receives the mixed audio stream and performs decoding and rendering of the mixed audio stream. In some examples the receiving participant device 105 can decode the main stream 601 and the one or more sub streams 603 separately. The receiving participant device 105 can then enable audio content to be played back to the user of the receiving participant device 105.

FIG. 9 shows an example system 101 that can be used to implement examples of the disclosure. The system 101 could be an IVAS system. The system could use a MASA format or any other suitable type of format.

The example system 101 in FIG. 9 comprises a control unit 103 and three participant devices 105. In this example the first participant device 105A is configured to be a receiving participant device 105A and the second participant device 105B and the third participant device 105C are sending participant devices 105. It is to be appreciated that the respective participant devices 105 could both send and receive audio signals in examples of the disclosure.

In this example the control unit 103 comprises a session controller module 901, an encoder/decoder module 903, a selection module 905 and a transport stream module 907. In other examples the control unit 103 can comprise different modules and/or combinations of modules.

The session controller module 901 can be configured to establish a communication session between the control unit 103 and the respective participant devices 105. The session controller module 901 can be configured to receive session negotiation signaling from the respective participant devices 105. The session controller module 901 can be configured to negotiate parameters for a multimedia session between sending participant devices 105B, 105C and receiving participant devices 105A.

The encoder/decoder module 903 is configured to decode received audio signals that are received from the respective sending participant devices 105B, 105C. The encoder/decoder module 903 is also configured to encode a mixed audio stream for sending to a receiving participant device 105A. The encoder/decoder module 903 can comprise a MASA encoder/decoder or any other suitable type of encoder.

The selection module 905 can be configured to select the mode that is to be used for the mixed audio stream. The selection module 905 can receive information indicative of the available modes for the selected input format for the respective sending participant devices 105. The selection modules 905 can also receive information relating to preferences, such as computational requirements, for the receiving participant device 105A. The selection modules 905 can select the mode to be used for the mixing using any of the methods or processes described herein.

The transport stream module 907 can be configured to generate a transport audio stream. The transport stream can use any suitable protocol such as Real-time

Transport Protocol (RTP). The transport stream module 907 provides an encoded stream as a payload.

The respective participant devices 105 also comprise a microphone array 909 a session controller module 911, an encoder/decoder module 913, a processing module 915 and a transport stream module 917. In other examples the control unit 103 can comprise different modules and/or combinations of modules.

The microphone array 909 can comprise multiple microphones. The microphones are configured to capture sound and produce electrical output signals. The microphones within the microphones array 909 can be spatially arranged so as to enable spatial audio to be captured.

The participant devices 105 are configured so that the output signals from the microphone array 909 are provided to a processing module 915. The processing module 915 is configured to process the microphone signals into the selected format. The processing module 915 is configured to process the microphone signals into the selected mode of the selected format.

The participant devices 105 are configured so that the output signals from the processing modules 915 are provided as an input to the encoder module 913. The encoder module 913 is configured to encode the processed microphone signals for sending to the control unit 103. The encoder module 913 can comprise a MASA encoder or any other suitable type of encoder.

The encoded signals are provided to a transport stream module 917. The transport stream module 917 can be configured to generate a transport audio stream. The transport stream can use any suitable protocol such as Real-time Transport Protocol (RTP). The transport stream module 917 provides an encoded stream as a payload. The encoded stream can be transmitted to the control unit 103.

The session controller module 911 can be configured to establish a communication session between the control unit 103. The session controller module 911 can be configured to transmit session negotiation signaling to the control unit 103. The session controller module 911 can be configured to negotiate parameters for a multimedia session between the participant device 105 and the control unit 103. The session controller module 911 of the participant devices 105 is configured to send signals to the session controller module 911 of the control unit 103.

The participant devices can also be configured to receive head tracking information. The head tracking information can be received from one or more positioning device or sensors configured to monitor the user 111. This information can be used by the participant devices 105 to determine a user's head orientation and to render the received audio stream.

In the example of FIG. 9 the participant devices 105 are identical. The participant devices 105 could be different in other examples.

FIG. 10 schematically illustrates an apparatus 1001 that can be used to implement examples of the disclosure. In this example the apparatus 1001 comprises a controller 1003. The controller 1003 can be a chip or a chip-set. The apparatus 1001 can be provided within a control unit 103 or a participant device 105 or any other suitable device.

In the example of FIG. 10 the implementation of the controller 1003 can be as controller circuitry. In some examples the controller 1003 can be implemented in hardware alone, have certain aspects in software including firmware alone or can be a combination of hardware and software (including firmware).

As illustrated in FIG. 10 the controller 1003 can be implemented using instructions that enable hardware functionality, for example, by using executable instructions of a computer program 1009 in a general-purpose or special-purpose processor 1005 that may be stored on a computer readable storage medium (disk, memory etc.) to be executed by such a processor 1005.

The processor 1005 is configured to read from and write to the memory 1007. The processor 1005 can also comprise an output interface via which data and/or commands are output by the processor 1005 and an input interface via which data and/or commands are input to the processor 1005.

The memory 1007 stores a computer program 1009 comprising computer program instructions (computer program code 1011) that controls the operation of the controller 1003 when loaded into the processor 1005. The computer program instructions, of the computer program 1009, provide the logic and routines that enables the controller 1003 to perform the methods illustrated in the accompanying Figs. The processor 1005 by reading the memory 1007 is able to load and execute the computer program 1009.

The apparatus 1001 comprises:
at least one processor 1005; and
at least one memory 1007 storing instructions that, when executed by the at least one processor 1005, cause the apparatus 1001 at least to perform:
   obtaining 501 an indication of one or more modes available for a selected input format of a first audio signal wherein the first audio signal is received from a first source;
   obtaining 503 an indication of one or more modes available for a selected input format of a second audio signal wherein the second audio signal is received from a second source and wherein the first audio signal and the second audio signal are to be combined to form an audio stream;
   selecting 505 a mode for the audio stream comprising both the first audio signal and the second audio signal wherein the selection is based, at least in part, on one or more common modes available for the selected input format of the first audio signal and the selected input format of the second audio signal;
   sending 507 an indication of the selected mode to the respective sources.

As illustrated in FIG. 10, the computer program 1009 can arrive at the controller 1003 via any suitable delivery mechanism 1013. The delivery mechanism 1013 can be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 1009. The delivery mechanism can be a signal configured to reliably transfer the computer program 1009. The controller 1003 can propagate or transmit the computer program 1009 as a computer data signal. In some examples the computer program 1009 can be transmitted to the controller 1003 using a wireless protocol such as Bluetooth, Bluetooth Low Energy, Bluetooth Smart, 6LoWPan (IPV6 over low power personal area networks) ZigBee, ANT+, near field communication (NFC), Radio frequency identification, wireless local area network (wireless LAN) or any other suitable protocol.

The computer program 1009 comprises computer program instructions for causing an apparatus 1001 to perform at least the following or for performing at least the following:
obtaining 501 an indication of one or more modes available for a selected input format of a first audio signal wherein the first audio signal is received from a first source;
obtaining 503 an indication of one or more modes available for a selected input format of a second audio signal wherein the second audio signal is received from a second source and wherein the first audio signal and the second audio signal are to be combined to form an audio stream;
selecting 505 a mode for the audio stream comprising both the first audio signal and the second audio signal wherein the selection is based, at least in part, on one or more common modes available for the selected input format of the first audio signal and the selected input format of the second audio signal;
sending 507 an indication of the selected mode to the respective sources.

The computer program instructions can be comprised in a computer program 1009, a non-transitory computer readable medium, a computer program product, a machine readable medium. In some but not necessarily all examples, the computer program instructions can be distributed over more than one computer program 1009.

Although the memory 1007 is illustrated as a single component/circuitry it can be implemented as one or more separate components/circuitry some or all of which can be integrated/removable and/or can provide permanent/semi-permanent/dynamic/cached storage.

Although the processor 1005 is illustrated as a single component/circuitry it can be implemented as one or more separate components/circuitry some or all of which can be integrated/removable. The processor 1005 can be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory or memories that work together to cause an apparatus, such as a mobile phone or server, to perform various functions and (c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in FIGS. 4 and 8 can represent steps in a method and/or sections of code in the computer program 1009. The illustration of a particular order to the blocks does not necessarily imply that there is a required or preferred order for the blocks and the order and arrangement of the blocks can be varied. Furthermore, it can be possible for some blocks to be omitted.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. An apparatus comprising:
at least one processor; and
at least one memory storing instructions that, when executed with the at least one processor, cause the apparatus at least to:
obtain an indication of one or more modes available for a selected input format of a first audio signal wherein the first audio signal is received from a first source;
obtain an indication of one or more modes available for a selected input format of a second audio signal wherein the second audio signal is received from a second source and wherein the first audio signal and the second audio signal are to be combined to form an audio stream;
select a mode for the audio stream comprising both the first audio signal and the second audio signal, wherein the selection is based, at least in part, on one or more common modes available for the selected input format of the first audio signal and the selected input format of the second audio signal; and
send an indication of the selected mode to the respective sources.

2. An apparatus as claimed in claim 1, wherein the indications of the available modes are received for more than two audio signals from different sources and different audio signals can have different modes available for selected input formats and wherein the audio signals are to be combined to form an audio stream.

3. An apparatus as claimed in claim 1, wherein the selected mode comprises a mode that is common to two or more audio signals where the audio signals are from two or more sources.

4. An apparatus as claimed in claim 1, wherein the mode is selected, based at least in part on at least one of:
most common available mode for the selected input formats for the sources;
computational load for mixing the audio signals from the sources into a combined stream in the respective available modes for the selected input formats; or
computational load for at least one of decoding the audio signals from the sources or encoding a mixed audio stream in the respective available modes for the selected input formats.

5. An apparatus as claimed in claim 1, wherein the instructions, when executed with the at least one processor, cause the apparatus to mix at least the first audio signal and at least the second audio signal using a common mode to generate a mixed audio stream in the selected mode and enabling transmission of the mixed audio stream.

6. An apparatus as claimed in claim 1, wherein the selected mode comprises a first mode for an audio main stream and a second mode for an audio substream.

7. An apparatus as claimed in claim 6, wherein the audio main stream comprises a mix of two or more audio signals with a common mode in the selected input formats.

8. An apparatus as claimed in claim 6, wherein the instructions, when executed with the at least one processor, cause the apparatus to enable the audio main stream and the sub stream substream to be transmitted without mixing the audio main stream and the substream.

9. An apparatus as claimed in claim 1, wherein the instructions, when executed with the at least one processor, cause the apparatus to receive an indication of a preferred mode for an end user device and using the indication of the preferred mode to assist the selecting of the mode for the audio stream.

10. An apparatus as claimed in claim 1, wherein the audio signals comprise metadata assisted spatial audio signals.

11. An apparatus as claimed in claim 1, wherein the selected input formats comprise a metadata assisted spatial audio format.

12. An apparatus as claimed in claim 1, wherein the one or more modes available for an input format comprise a time-frequency resolution.

13. An apparatus as claimed in claim 12, wherein at least one of the available modes comprises a higher frequency resolution and at least one of the available modes comprises a higher temporal resolution.

14. An apparatus as claimed in claim 1, wherein the instructions, when executed with the at least one processor, cause the apparatus to generate spatial metadata using the selected mode.

15. A method comprising:
obtaining an indication of one or more modes available for a selected input format of a first audio signal wherein the first audio signal is received from a first source;
obtaining an indication of one or more modes available for a selected input format of a second audio signal wherein the second audio signal is received from a second source and wherein the first audio signal and the second audio signal are to be combined to form an audio stream;
selecting a mode for the audio stream comprising both the first audio signal and the second audio signal, wherein the selection is based, at least in part, on one or more common modes available for the selected input format of the first audio signal and the selected input format of the second audio signal; and
sending an indication of the selected mode to the respective sources.

16-18. (canceled)

19. A method as claimed in claim 15, wherein the mode is selected, based at least in part on at least one of:
most common available mode for the selected input formats for the sources;
computational load for mixing the audio signals from the sources into a combined stream in the respective available modes for the selected input formats; or
computational load for at least one of decoding the audio signals from the sources or encoding a mixed audio stream in the respective available modes for the selected input formats.

20. A method as claimed in claim 15, further comprising mixing at least the first audio signal and at least the second audio signal using a common mode to generate a mixed audio stream in the selected mode
and enabling transmission of the mixed audio stream.

21-23. (canceled)

24. A method as claimed in claim 15, wherein the indications of the available modes are received for more than two audio signals from different sources and different audio signals can have different modes available for selected input formats and wherein the audio signals are to be combined to form an audio stream.

25. A method as claimed in claim 15, wherein the one or more modes available for an input format comprise a time-frequency resolution.

26. A method as claimed in claim 25, wherein at least one of the available modes comprises a higher frequency resolution and at least one of the available modes comprises a higher temporal resolution.
